(19) United States
(12) Patent Application Publication
(10) Pub. No.: US 2013/0179203 A1
(43) Pub. Date: Jul. 11, 2013

(54) BLOCKING ACCESS TO PROJECT DATA IN RESPONSE TO FAILURE TO INDICATE ATTENDANCE AT PROJECT MEETINGS

(71) Applicants: Shawn P. Mullen, Buda, TX (US); Jessica C. Murillo, Round Rock, TX (US); Johnny M. Shieh, Austin, TX (US)

(72) Inventors: Shawn P. Mullen, Buda, TX (US); Jessica C. Murillo, Round Rock, TX (US); Johnny M. Shieh, Austin, TX (US)

(73) Assignee: INTERNATIONAL BUSINESS MACHINES CORPORATION, Armonk, NY (US)

(21) Appl. No.: 13/346,487

(22) Filed: Jan. 9, 2012

(51) Int. Cl. G06Q 10/06

(52) U.S. Cl. 705/7.11

(57) ABSTRACT

A method for restricting access to project data includes determining that a user has failed to indicate an intention to attend a meeting by failing to respond to a meeting notice or by indicating that the user will not participate in the meeting. The meeting notice includes an invitation sent electronically to the user to attend a meeting, and the user has electronic access to data by way of permissions associated with a user account assigned to the user. The meeting is related to the data. The method includes recording a failure-to-attend event in response to determining that the user has failed to indicate an intention to attend a meeting. The method includes blocking the user from accessing the user account in response to a quantity of failure-to-attend events reaching non-attendance criteria.

### BACKGROUND

1. Field

The subject matter disclosed herein relates to data access and more particularly relates to removing data access based on non-acceptance of a meeting notice.

2. Description of the Related Art

When people collaborate on a project, often it is beneficial to store data associated with the project electronically. The data may be stored in a particular file structure on a computer, for example in folders, in a database, or other organized data structure. Access to the data is often restricted, for example, to those assigned to the project. The number of collaborators on a project may be large and typically requires management to ensure that only those assigned to the project have access to the data.

Often meetings are called to coordinate work done on the project. Meeting notices may be sent out inviting some or all of the people assigned to the project. The meeting notices typically are sent electronically using a calendaring program. Typically the meeting notice will request that the invitee indicate whether or not the invitee is planning on attending the meeting. Some options for an invitee may include accepting the meeting invitation, declining the meeting invitation, assigning a proxy to attend in place of the invitee, and ignoring the meeting invitation.

### BRIEF SUMMARY

A method for restricting access to project data based on non-response or negative response to electronic meeting invitations is disclosed. An apparatus, system, and computer program product also perform the functions of the method. The method includes determining that a user has failed to indicate an intention to attend a meeting. In one embodiment, the method determines that a user has failed to indicate an intention to attend a meeting by failing to respond to a meeting notice. In another embodiment, the method determines that a user has failed to indicate an intention to attend a meeting when the user responds to the meeting notice by indicating that the user will not participate in the meeting. In one embodiment, the meeting notice includes an invitation sent electronically to the user to attend a meeting, and the user has electronic access to data by way of permissions associated with a user account assigned to the user. The meeting is related to the data.

The method, in one embodiment, includes recording a failure-to-attend event in response to determining that the user has failed to indicate an intention to attend a meeting. The method, in another embodiment, includes blocking the user from accessing the user account in response to a quantity of failure-to-attend events reaching non-attendance criteria.

In one embodiment, the method further includes notifying the user that access to the user account has been blocked in response to blocking the user from accessing the user account. In another embodiment, the method further includes sending a warning message to the user that access to the user account will be blocked with further non-attendance to meetings in response to the quantity of failure-to-attend events reaching warning criteria. Typically the warning criteria are lower than the non-attendance criteria. In one embodiment, recording a failure-to-attend event further includes recording, in two or more non-attendance categories, responding to the meeting notice by indicating that the user will not participate in the meeting and failing to respond to a meeting notice. In another example, the non-attendance criteria includes a separate criteria for each non-attendance category, and the method also includes blocking the user from accessing the user account in response to a quantity of failure-to-attend events in a particular category reaching non-attendance criteria for the particular category.

In one embodiment, the method includes not recording a failure-to-attend event in response to an excused absence from the meeting. An excused absence from the meeting may include an indication that the user is absent due to one or more of vacation, business travel, temporary re-assignment, inability to work, a family emergency, a meeting conflict, a directive from a supervisor of the user to not attend the meeting, or other excuse deemed acceptable.

In one embodiment, the data is stored in a database and is part of a project and the user is assigned to the project, and blocking access to the user account also includes removing the user from the project. In another embodiment, the meeting notice is sent by way of a calendaring program and determining that the user has failed to indicate an intention to attend the meeting includes monitoring responses using the calendaring program, where the calendaring program is linked to a database storing the data. In another embodiment, the method includes providing a notification to a system administrator when the user is blocked from accessing the user account. In another embodiment, responding to the meeting notice by indicating that the user will not participate in the meeting includes one or more of declining the invitation to attend and delegating attendance to another user.

In one example, the data is accessible to multiple users and the meeting notice is sent to users that have access to the data, and determining an intention to attend a meeting is tracked for each user. In another example, the method includes recording a failure-to-attend event in response to determining that the user failed to attend the meeting after the user accepted the meeting invitation. In another example, the non-attendance criteria also include decreasing the quantity of failure-to-attend events in response to determining that the user agreed to attend a meeting. In yet another example, the non-attendance criteria also include a quantity of failure-to-attend events reaching a non-attendance threshold within a window of time.

In one embodiment, an apparatus includes an invitation module, a non-attendance tracking module, and an access removal module. The invitation status module, in one embodiment, determines that a user has failed to indicate an intention to attend a meeting by failing to respond to a meeting notice or by responding to the meeting notice by indicating that the user will not participate in the meeting. The meeting notice includes an invitation sent electronically to the user to attend a meeting. The user has electronic access to data by way of permissions associated with a user account assigned to the user, where the meeting is related to the data.

The non-attendance tracking module records a failure-to-attend event in response to the invitation status module determining that the user has failed to indicate an intention to attend a meeting. The access removal module blocks the user from accessing the user account in response to a quantity of failure-to-attend events reaching non-attendance criteria.

In one embodiment, the apparatus includes a warning module that notifies the user that access to the user account has been blocked in response to blocking the user from accessing the user account. In another embodiment, the warning module sends a warning message to the user that access to the user account will be blocked with further non-attendance to meetings in response to the quantity of failure-to-attend events reaching warning criteria. In one embodiment, the warning criteria are lower than the non-attendance criteria. In another embodiment, the apparatus includes an excused absence module that prevents recording a failure-to-attend event in response to an excused absence from the meeting. In yet another embodiment, the apparatus includes a notification module that provides a notification to a system administrator when the user is blocked from accessing the user account.

One embodiment, of a system of the present invention includes a computer, a data storage device in communication with the computer, and an access removal apparatus. The data storage device stores data, typically related to a project. The access removal apparatus includes an invitation module, a non-attendance tracking module, and an access removal module.

The invitation status module determines that a user has failed to indicate an intention to attend a meeting by failing to respond to a meeting notice or by responding to the meeting notice by indicating that the user will not participate in the meeting. The meeting notice includes an invitation sent electronically to the user to attend a meeting. The user has electronic access to the data by way of permissions associated with a user account assigned to the user, where the meeting is related to the data.

The non-attendance tracking module records a failure-to-attend event in response to the invitation status module determining that the user has failed to indicate an intention to attend a meeting. The access removal module blocks the user from accessing the user account in response to a quantity of failure-to-attend events reaching non-attendance criteria.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for controlling access to data in accordance with the present invention;

FIG. 2 is a schematic block diagram illustrating one embodiment of a user removal apparatus for controlling access to data in accordance with the present invention;

FIG. 3 is a schematic block diagram illustrating and alternate embodiment of a user removal apparatus for controlling access to data in accordance with the present invention;

FIG. 4 is a schematic flow chart diagram illustrating one embodiment of a method for controlling access to data in accordance with the present invention; and

FIG. 5 is a schematic flow chart diagram illustrating one embodiment of an alternate method for controlling access to data in accordance with the present invention.

### DETAILED DESCRIPTION

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, apparatus, computer program product, or the like. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, a solid-state non-volatile storage medium, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

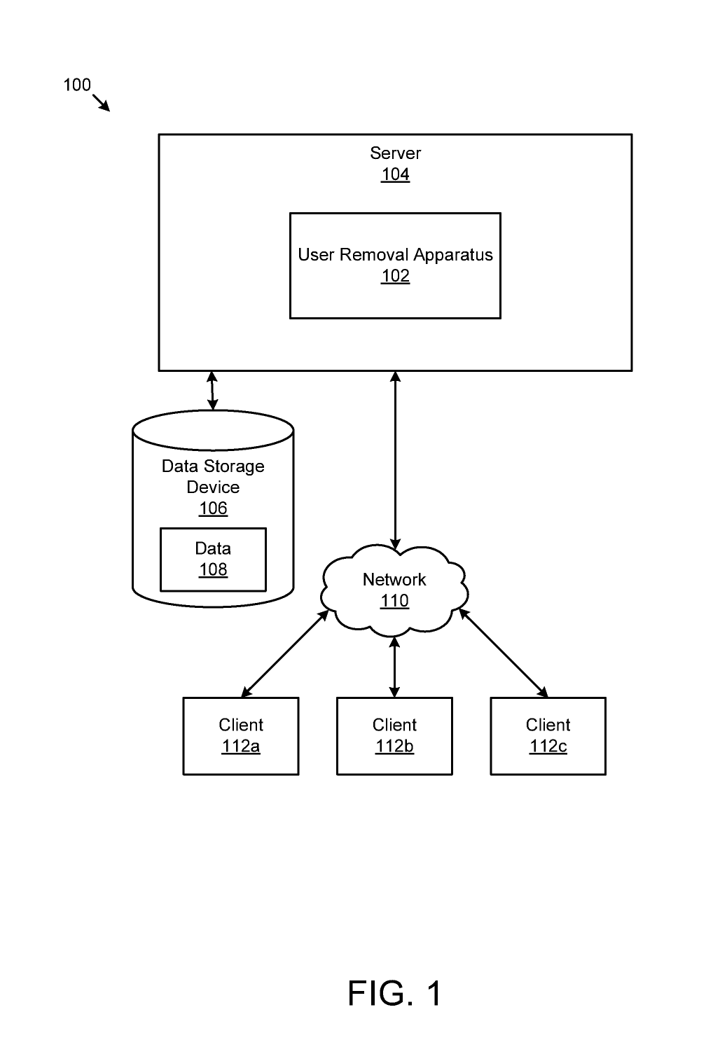

FIG. 1 is a schematic block diagram illustrating one embodiment of a system 100 for controlling access to data in accordance with the present invention. The system 100 includes a user removal apparatus 102 in a server 104. The server 104 is in communication with a data storage device 106 that is storing data 108. The server 104 is in communication with clients 112a, 112b, 112c (collectively 112) through a network 110. The server 104 typically includes one or more processors running one or more instances of an operating system. The server 104 is one form of a computer and may be a desktop computer, a workstation, a mainframe computer, a computer with two or more virtual machines, and the like. While a server 104 is shown, any type of computer that may include the user removal apparatus 102 is contemplated herein. For example, the server 104 may be a laptop computer, smart phone, a touchpad computer, a notebook computer, or other mobile device, or may be incorporated into another device that includes a processor.

The user removal apparatus 102, in one embodiment, may be included in the server 104 as shown but all or part of the user removal apparatus 102 may be located elsewhere. In one embodiment, the user removal apparatus 102 may be in the form of executable code stored on the data storage device 106 and loaded into memory of the server 104 when executing. In some embodiments, all or part of the user removal apparatus 102 may be implemented using logic hardware, such as a field programmable logic array (“FPGA”), application specific integrated circuit (“ASIC”), or the like. One of skill in the art will recognize other ways to implement the user removal apparatus 102.

The data storage device 106, in one embodiment, may be external to the server 104 as shown. The data storage device 106 may be connected through a network, such as a storage area network (“SAN”), may be connected through a universal serial bus (“USB”) connection, or other data connection. In other embodiments, the data storage device 106 may be internal to the server and may be connected by way of a Serial Advanced Technology Attachment (“SATA” or “Serial ATA”) connection, peripheral component interconnect (“PCI”), PCI Express, or other suitable connection. In other embodiments, the server 104 may connect to more than one data storage device 106, which may be external, internal, or both. One of skill in the art will recognize other ways to implement and connect a data storage device 106.

The data storage device 106 includes data 108 where access is controlled or limited. In one embodiment, data access is controlled or limited by the user removal apparatus 102. The data 108 may be in the form of files in a folder, data stored at a particular location, a database, or other data structure where access may be limited. The data 108, in one embodiment, is data associated with a project. The project may be any task, group of related tasks, assignment or other activity where multiple people are assigned and need access to the data 108. In one embodiment, the data 108 includes meeting minutes, notes, programs, documents, research, or any other information that may be stored on the data storage device 106. One of skill in the art will recognize other activities, projects, assignments, etc. where multiple people will have access to data 108.

The network 110 may be any computer network capable of transmitting information between the server 104 and clients 112. For example, the network 110 may be local area network (“LAN”), a wide area network (“WAN”), a fiber optic network, a wireless network, an internet, and may include multiple network types. The network 110 may include servers, routers, and the like. One of skill in the art will recognize that the network 110 may be any network capable of transmitting data for communication between clients 112 and a server 104.

The system 100 may include any number of clients 112. A client (e.g. 112a) may be a desktop computer, a laptop computer, a workstation, a terminal, a mobile electronic device, and the like. Typically a client 112a communicates with the server 104 and a user may access the data 108 through the client 112a. In one embodiment, a client 112 is within the server 104 and a user accesses the data 108 through the client 112 on the server 104. In yet another embodiment, a user accesses to the data 108 directly through the server 104.

Access to the data 108 is typically controlled and data access may be limited by way of a user account that is accessible using a user name and password. Typically a user account is set up by an administrator and the administrator sets up controls to limit access to the data 108 using an account set up for the user. In one embodiment, each user has a unique user account. The user account may include access to data that is only available to the user. In other embodiments, the user also has access to the data 108 along with other users. Some of the data only accessible to a user may be project data 108 and access may be limited using the user removal apparatus 102. One of skill in the art will recognize other ways to control access to the data 108 and to use the user removal apparatus 102 to limit or remove access to the data 108 by a user.

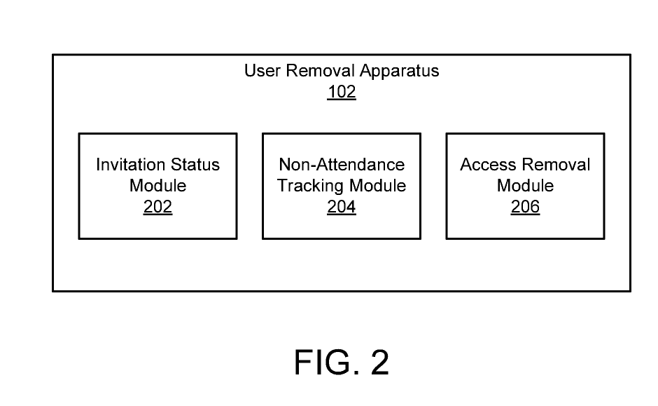

FIG. 2 is a schematic block diagram illustrating one embodiment of a user removal apparatus 102 for controlling access to data in accordance with the present invention. The user removal apparatus 102 includes an invitation status module 202, a non-attendance tracking module 204, and an access removal module 206, which are described below. In general, the user removal apparatus 102 tracks meeting notice acceptance and non-acceptance, and may track meeting attendance, and removes user access to project data when non-attendance of the user, as manifest through non-response to meeting notices or the user indicating an intention of non-attendance, meets non-attendance criteria.

The invitation status module 202 determines that a user has failed to indicate an intention to attend a meeting. For example, the invitation status module 202 may determine that the user failed to respond to a meeting notice. In another example, the invitation status module 202 may determine that the user responded to the meeting notice by indicating that the user will not participate in the meeting. In one embodiment, the meeting notice includes an invitation sent electronically to the user to attend a meeting and the user has electronic access to the data 108 by way of permissions associated with a user account assigned to the user. Typically the meeting is related to the data in some way. For example, the data 108 may include meeting minutes, project data discussed in the meeting, data for the project and the meeting is about the project, etc.

In one embodiment, the data 108 is accessible to two or more users and the invitation status module 202 monitors meeting notice responses for each user with access to the data 108. Typically, the two or more users are assigned to work on or participate in some way with a project and the data 108 is data associated with the project. In one embodiment, the project has a large number of users assigned to the project, and the invitation status module 202 monitors meeting notice responses for each user.

The invitation status module 202, in one embodiment, is part of or associated with a calendaring program that allows electronic meeting notices. For example, after someone associated with a project sends out a meeting notice to the user by way of the calendaring program, the invitation status module 202 may monitor responses from the user to the meeting notice and may determine that the user has not responded if a response is not received before the meeting or by a deadline. In another embodiment, the invitation status module 202 may monitor the meeting notice and may determine that the user has not responded by determining that the user has not opened the meeting notice before the meeting or before a deadline. One of skill in the art will recognize other ways that the invitation status module 202 may determine that a user has not responded to a meeting notice.

The invitation status module 202 may determine in various ways that the user responded to the meeting notice by indicating that the user will not participate in the meeting. For example, the user may decline the meeting and the invitation status module 202 may log the response as the user failing to indicate an intention to attend the meeting. In another example, the user may designate a proxy to attend the meeting in place of the user and the invitation status module 202 may interpret the response as the user failing to indicate an intention to attend the meeting.

Other examples of indicating that the user will not participate in the meeting may include the user indicating a preference not to receive further meeting notices, the user indicating a transfer from the project, an auto-reply from the user indicating that the user is out of the office, on vacation, away on business, etc., the user indicating a termination of employment, or any other indication that may be interpreted as the user indicating that the user will not participate in or attend the meeting. The invitation status module 202 may interpret any of the above mentioned user responses as a failure to indicate an intention to attend the meeting. One of skill in the art will recognize other ways that the invitation status module 202 may determine that a user has failed to indicate an intention to attend the meeting.

In one embodiment, the user removal apparatus 102 includes a non-attendance tracking module 204 that records a failure-to-attend event in response to the invitation status module 202 determining that the user has failed to indicate an intention to attend a meeting. In one embodiment, the non-attendance tracking module 204 records a failure-to-attend event by increasing a count. The count may be tracked using a counter, a register, a stack, or any other means for tracking a count. For example, the non-attendance tracking module 204 may include a counter for each user. In another embodiment, the non-attendance tracking module 204 records a failure-to-attend event by logging the failure-to-attend event in a journal, a log, or other data storage structure.

In one embodiment, the non-attendance tracking module 204 records a failure-to-attend event by logging more than a simple count. For example, the non-attendance tracking module 204 may increase a count and may also indicate a type of response of the user or lack of response by the user. In another embodiment, the non-attendance tracking module 204 tracks different types or categories of failure to indicate an intention to attend a meeting by using multiple counters for each user where, for example, each counter assigned to a user is used to record failure-to-attend events for in at least one different type or category. For example, a failure to respond to a meeting notice may be in one category and may be tracked separately than a response by the user indicating an intention to not attend the meeting.

In other examples, the non-attendance tracking module 204 tracks each different type of response separately in addition to separately tracking non-responses. In another example, the non-attendance tracking module 204 tracks an overall number of failure-to-attend events as well as failure-to-attend events for each response or non-response type. In one embodiment, the non-attendance tracking module 204 tracks the user agreeing to attend a meeting. In another embodiment, the non-attendance tracking module 204 may track actual meeting attendance. For example, if the meeting uses electronic media, a user may log into the meeting electronically to access meeting images and sound. In another example, attendees at an in-person meeting may be input electronically so that the non-attendance tracking module 204 may track attendance.

The non-attendance tracking module 204 may track an intention to attend the meeting and/or actual attendance in various ways. For example, the non-attendance tracking module 204 may track an intention to attend the meeting and/or actual attendance in separate counters, logs, etc. In another example, the non-attendance tracking module 204 may track an intention to attend the meeting and/or actual attendance by adjusting recording of failure-to-attend events, such as decreasing one or more counters. One of skill in the art will recognize other ways that the non-attendance tracking module 204 may record and/or track failure-to-attend events in response to the invitation status module 202 determining that the user has failed to indicate an intention to attend a meeting and to factor in intention to attend events, and/or actual attendance.

The user removal apparatus 102, in one embodiment, includes an access removal module 206 that blocks the user from accessing the user account of the user in response to a quantity of failure-to-attend events reaching non-attendance criteria. The non-attendance criteria may take many forms. For example, the non-attendance criteria may be a non-attendance threshold. In another example, the non-attendance criteria may be a certain number of failure-to-attend events within a certain time window. In another example, the non-attendance criteria may include a ratio of failure-to-attend events to positive indications of an intention to attend meetings. One of skill in the art will recognize other non-attendance criteria.

In one embodiment, the access removal module 206 includes multiple non-attendance criteria and blocks the user from accessing the user account in response to reaching one or more of the various non-attendance criteria. In another embodiment where the non-attendance tracking module 204 records failure-to-attend events in multiple categories, the access removal module 206 blocks the user from accessing the user account in response to a quantity of failure-to-attend events in a particular category reaching non-attendance criteria for the particular category. For example, non-response to a meeting notice may be one category, declining a meeting notice may be another category, assigning a proxy to attend the meeting in place of the user (i.e. delegating attendance to another user) may be another category, etc. The non-attendance criteria may be different for each category.

In one embodiment, non-attendance criteria for non-response to a meeting notice may include a non-response threshold that is lower than a threshold for a non-attendance criteria associated with assigning a proxy to attend in place of a user (i.e. delegating attendance to another user). The various non-attendance criteria may be tailored to recognize different reasons for non-attendance. The non-attendance criteria for non-response, for example, may be set low because non-response may be interpreted to mean that the user is reassigned, left the company, etc. while the non-attendance criteria associated with assigning a proxy may be high or unlimited recognizing that a manager may wish to still be involved in a project and may be getting updates from the proxy. In another example, declining a meeting may be viewed differently than non-response so the non-attendance criteria for declining a meeting may allow more non-attendance before blocking access to the user than for non-response.

The access removal module 206 blocks the user from accessing the data 108. Typically the user has access to the data 108 by way of a user account. In other embodiments, the access removal module 206 may block data access by changing data access through other means than changing a user account. The access removal module 206 may block access to the data 108 by the user by removing a user account of the user, changing permissions on the user account, removing the user from a project, removing user access to a database with project data, etc.

In one embodiment, the non-attendance criteria is adjusted based on an expressed intention by the user to attend a meeting and/or actual attendance. For example, non-attendance criteria may take into account meeting notice acceptance or actual attendance. In one embodiment, if the non-attendance criteria increase a counter for each non-response or indication of non-attendance, the counter may be decreased for an acceptance of a meeting notice. The counter may have a lower limit of failure-to-attend events, such as zero so that continued indication of meeting attendance may not drive the counter negative. In other embodiments, acceptance of a meeting notice may be used along with non-response or indication of non-attendance to formulate a ratio of non-meeting attendance to meeting attendance, may be used for non-attendance criteria that might reset a counter if a meeting notice is accepted, etc. One of skill in the art will recognize other non-attendance criteria that use acceptance of meeting notice information.

In another embodiment, actual meeting attendance may also be used as part of non-attendance criteria. For example, if a user indicates that the user will not participate in a meeting, but the non-attendance tracking module 204 or other module records actual attendance, recording of a failure-to-attend event may be removed or the failure-to-attend event may be not recorded. Likewise, if a failure-to-attend event is recorded for failure to respond to a meeting notice, but the user actually attends the meeting and the non-attendance tracking module 204 or other module records actual attendance, the non-attendance tracking module 204 may not record a failure-to-attend event or may otherwise remove a failure-to-attend event recorded based on the non-response to the meeting notice.

In yet another embodiment, the non-attendance tracking module 204 may use a determination that a user has failed to indicate an intention to attend a meeting, such as non-response to a meeting notice or an indication of non-attendance, in combination with a lack of an indication of actual meeting attendance to record a failure-to-attend event. One of skill in the art will recognize other ways that the access removal module 206 may use failure-to-attend events, indications of meeting attendance, actual meeting attendance, or other criteria to block a user from accessing the data 108.

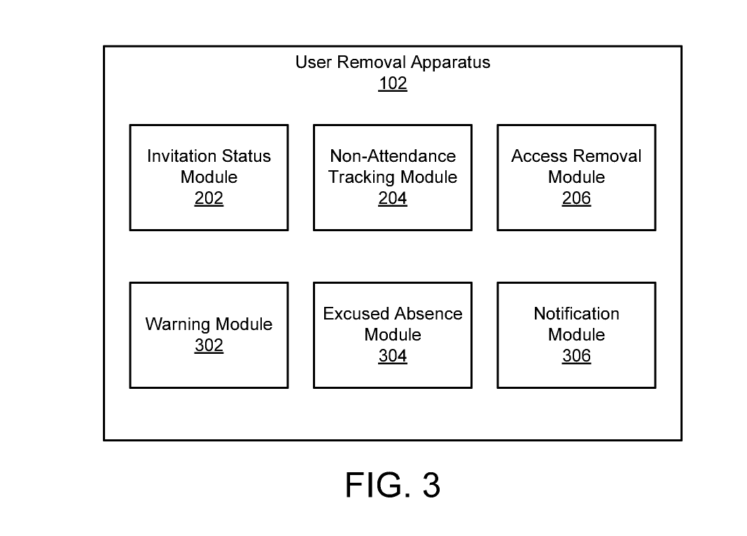

FIG. 3 is a schematic block diagram illustrating and alternate embodiment of a user removal apparatus 102 for controlling access to data in accordance with the present invention. In the embodiment, the user removal apparatus 102 includes an invitation status module 202, a non-attendance tracking module 204, and an access removal module 206, which are substantially similar to those in the embodiment of the user removal apparatus 102 described in relation to FIG. 2. In addition, the embodiment of the user removal apparatus 102 may include a warning module 302, an excused absence module 304, and a notification module 306, which are described below.

In one embodiment, the user removal apparatus 102 includes a warning module 302. In one embodiment, the warning module 302 notifies the user that access to the user account has been blocked in response to the access removal module 206 blocking the user from accessing the user account. In another embodiment, the access removal module 206 includes warning criteria that is lower than a non-attendance criteria and the warning module 302 sends a warning message to the user that access to the user account will be blocked with further non-attendance to meetings in response to the quantity of failure-to-attend events reaching a warning criteria. For example, if a non-attendance threshold is 10 failure-to-attend events (10 cumulative failure-to-attend events, 10 total failure-to-attend events in a time period, or the like), the warning module 302 may have a warning criteria of eight failure-to-attend events.

In various embodiments, the warning criteria may include multiple criteria, for example warning criteria for each type of tracked non-attendance category. The warning criteria may include, in some embodiments, multiple warning criteria for each criteria, may include different warning messages for each warning criteria, etc. The warning messages may be customized for each warning criteria. For example, if the non-attendance criteria is 10 failure-to-attend events, one warning criteria may be five failure-to-attend events and the warning module 302 may send a first message in response to quantity of failure-to-attend events reaching five, and another warning criteria may be eight failure-to-attend events and the warning module 302 may send a second message in response to quantity of failure-to-attend events reaching eight.

In various embodiments, the warning module 302 may send an email, a text message, a voice message, message appearing on the user's computer screen, or other communication that the user will be or is blocked from the user account and/or the data 108. The warning may take any form suitable to notify the user of blocked access or that future non-attendance will result in blocked access to the user account and/or to the data 108.

In one embodiment, the user removal apparatus 102 includes an excused absence module 304 that prevents recording of a failure-to-attend event by the non-attendance tracking module 204 in response to an excused absence from the meeting. An excused absence may be, for example, an indication that the user is absent from a meeting due to some reason deemed acceptable. Some examples of an excused absence may include vacation, business travel, temporary re-assignment, inability to work, a family emergency, a meeting conflict, a directive from a supervisor of the user to not attend the meeting, and the like.

In one embodiment, the excused absence module 304 prevents recording of a failure-to-attend event by the non-attendance tracking module 204. In another embodiment, the excused absence module 304 reverses recording of a failure-to-attend event. In another embodiment, the excused absence module 304 prevents or reverses recording of a failure-to-attend event in response to approval by a third party, such as a manager of the user. One of skill in the art will recognize other ways that the excused absence module 304 may prevent or reverse recording of a failure-to-attend event.

In one embodiment, the user removal apparatus 102 includes a notification module 306 that provides a notification to a system administrator when the user is blocked from accessing the user account. In another embodiment, the notification module 306 notifies a system administrator that the access removal module 206 has determined that a quantity of failure-to-attend events has reached a non-attendance criteria and the system administrator then blocks the user from accessing the data 108 by blocking access to the user account of the user. The notification module 306 may also notify other parties when the user is blocked from accessing the user account. One of skill in the art will recognize other ways that the notification module 306 may notify a system administrator or other party of blocked access to the user account.

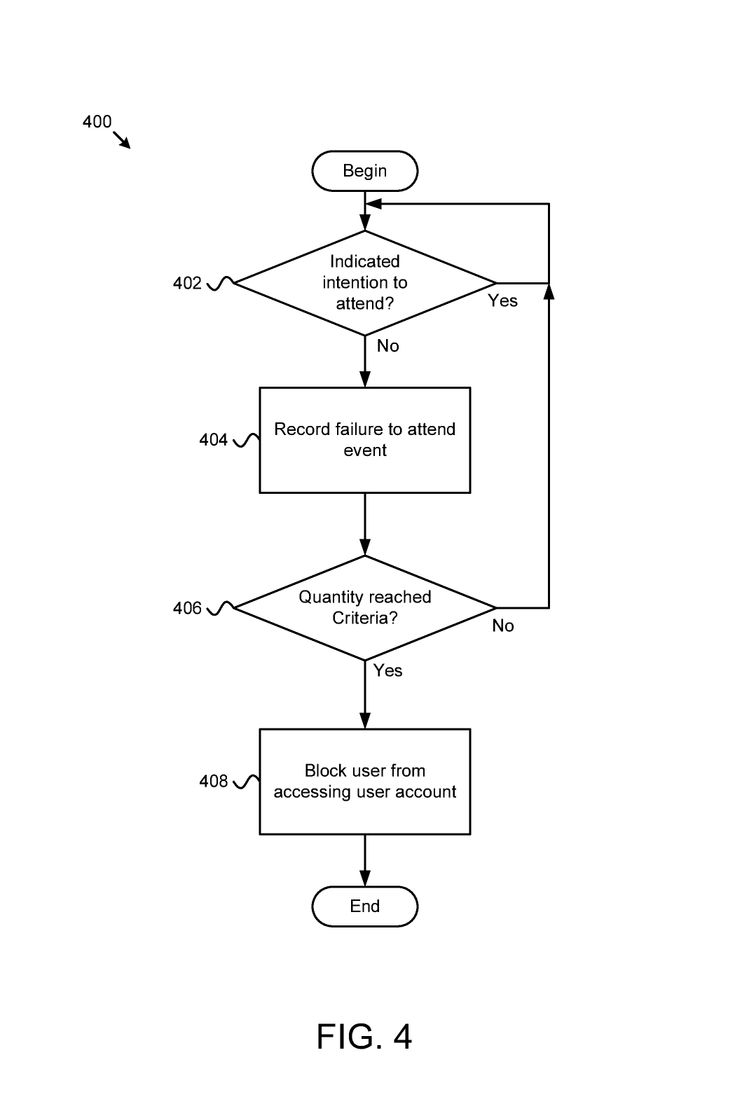

FIG. 4 is a schematic flow chart diagram illustrating one embodiment of a method 400 for controlling access to data in accordance with the present invention. The method 400 begins and the invitation status module 202 determines 402 if a user has failed to indicate an intention to attend a meeting by either failing to respond to a meeting notice or responding to the meeting notice by indicating that the user will not participate in the meeting. The user having access by way of a user account to data 108 associated with a project. If the invitation status module 202 determines 402 that the user has indicated an acceptance of the meeting notice, the method 400 returns and waits for a meeting notice, for example an additional meeting notice, such that the invitation status module 202 can determine 402 if a user has failed to indicate an intention to attend a meeting, such as an additional meeting.

If the invitation status module 202 determines 402 that the user has failed to indicate an intention to attend a meeting, the non-attendance tracking module 204 records 404 a failure-to-attend event. The access removal module 206 determines 406 if a quantity of failure-to-attend events has reached non-attendance criteria. If the access removal module 206 determines 406 that a quantity of failure-to-attend events has not reached non-attendance criteria, the method 400 returns and waits for an additional meeting notice such that the invitation status module 202 can determine 402 if a user has failed to indicate an intention to attend another meeting. If the access removal module 206 determines 406 that a quantity of failure-to-attend events has reached non-attendance criteria, the access removal module 206 blocks 408 the user from accessing the user account, and the method 400 ends.

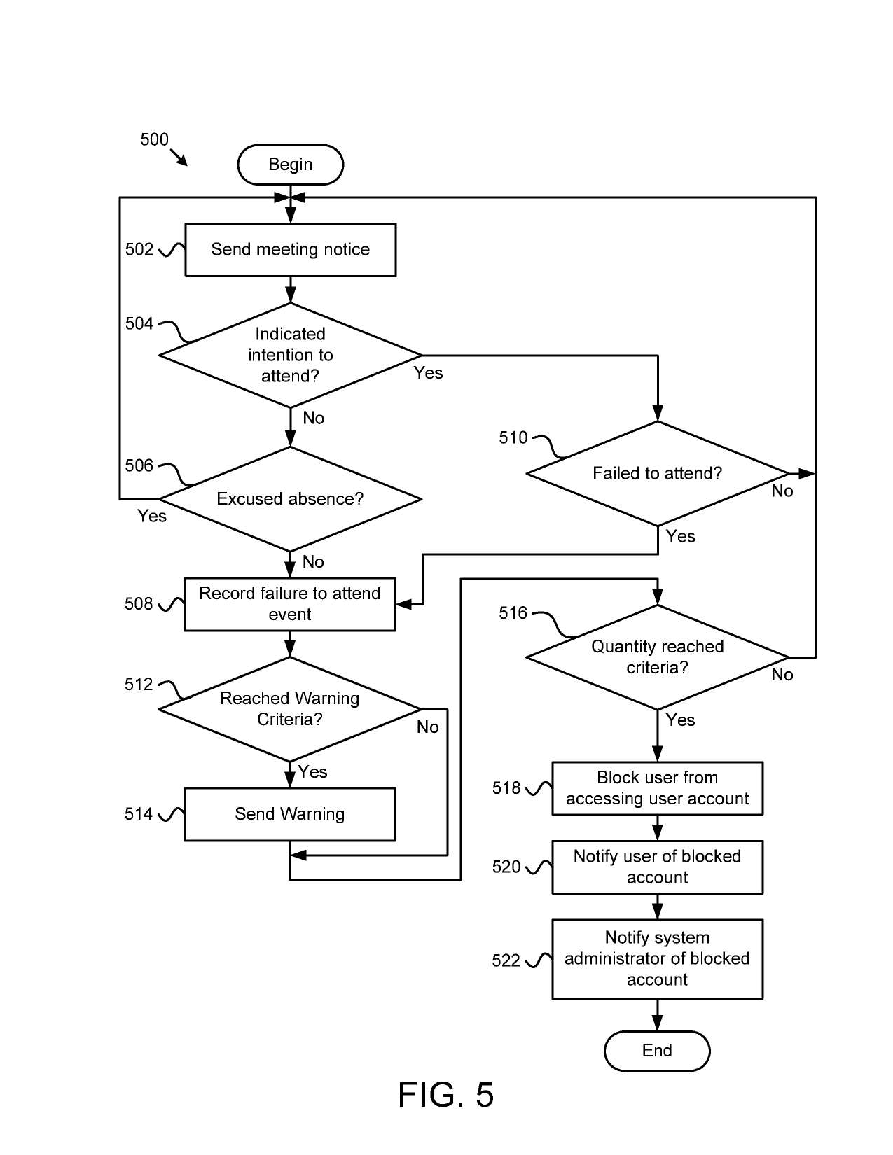

FIG. 5 is a schematic flow chart diagram illustrating one embodiment of an alternate method 500 for controlling access to data in accordance with the present invention. The method 500 begins and a user sends 502 a meeting notice through a calendaring system to one or more people invited to a meeting. At least some of the people invited to the meeting are users with a user account that allows access to the data 108 associated with a project. The invitation status module 202 determines 504 if a user that was sent a meeting notice has failed to indicate an intention to attend a meeting by either failing to respond to the meeting notice or by responding to the meeting notice by indicating that the user will not participate in the meeting. If the invitation status module 202 determines 504 that the user has not indicated an acceptance of the meeting notice, the excused absence module 304 determines 506 if absence from the meeting is excused.

If the excused absence module 304 determines 506 that absence from the meeting is excused, the method 500 returns and waits for the calendaring system to send an additional meeting notice. If the excused absence module 304 determines 506 that absence from the meeting is not excused, the non-attendance tracking module 204 records 508 a failure-to-attend event.

Returning back to step 504, if the invitation status module 202 determines 504 that the user has indicated an acceptance of the meeting notice, the non-attendance tracking module 204, in one embodiment determines 510 if the user attended the meeting. If the non-attendance tracking module 204 determines 510 that the user attended the meeting, the method 500 returns and waits for the calendaring system to send 502 a meeting notice for a meeting. If the non-attendance tracking module 204 determines 510 that the user has not attended the meeting, the non-attendance tracking module 204 records 508 a failure-to-attend event.

The warning module 302 determines 514 if a quantity of failure-to-attend events has reached warning criteria. If the warning module 302 determines 514 that a quantity of failure-to-attend events has not reached warning criteria, the access removal module 206 determines 516 if a quantity of failure-to-attend events has reached non-attendance criteria. If the warning module 302 determines 512 that a quantity of failure-to-attend events has reached warning criteria, the warning module 302 sends 514 a warning to the user, and the access removal module 206 determines 516 if a quantity of failure-to-attend events has reached non-attendance criteria. The warning may indicate that further non-attendance will result in the user being blocked from access to the user account of the user and to the data 108. The warning may be by email, text, or other notification means.

If the access removal module 206 determines 516 that a quantity of failure-to-attend events has not reached non-attendance criteria, the method 500 returns and waits for the calendaring system to send 502 a meeting notice for a meeting. If the access removal module 206 determines 516 that a quantity of failure-to-attend events has reached non-attendance criteria, the access removal module 206 blocks 518 the user from accessing the user account. In one embodiment, the notification module 306 notifies 520 the user that the user account of the user is blocked and, in another embodiment, the notification module 306 notifies 522 a system administrator that the user account of the user is blocked, and the method 500 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
determining that a user has failed to indicate an intention to attend a meeting by one of
failing to respond to a meeting notice, the meeting notice comprising an invitation sent electronically to the user to attend a meeting, the user having electronic access to data by way of permissions associated with a user account assigned to the user, the meeting being related to the data; and
responding to the meeting notice by indicating that the user will not participate in the meeting;
recording a failure-to-attend event in response to determining that the user has failed to indicate an intention to attend a meeting; and
blocking the user from accessing the user account in response to a quantity of failure-to-attend events reaching non-attendance criteria.

2. The method of claim 1, further comprising notifying the user that access to the user account has been blocked in response to blocking the user from accessing the user account.

3. The method of claim 1, further comprising sending a warning message to the user that access to the user account will be blocked with further non-attendance to meetings in response to the quantity of failure-to-attend events reaching warning criteria, the warning criteria being lower than the non-attendance criteria.

4. The method of claim 1, wherein recording a failure-to-attend event further comprises recording, in two or more non-attendance categories, responding to the meeting notice by indicating that the user will not participate in the meeting and failing to respond to a meeting notice.

5. The method of claim 4, wherein the non-attendance criteria comprises a separate criteria for each non-attendance category, and further comprising blocking the user from accessing the user account in response to a quantity of failure-to-attend events in a particular category reaching non-attendance criteria for the particular category.

6. The method of claim 1, further comprising not recording a failure-to-attend event in response to an excused absence from the meeting.

7. The method of claim 6, wherein an excused absence from the meeting comprises an indication that the user is absent due to one or more of vacation, business travel, temporary re-assignment, inability to work, a family emergency, a meeting conflict, and a directive from a supervisor of the user to not attend the meeting.

8. The method of claim 1, wherein the data is stored in a database and is part of a project and the user is assigned to the project, and wherein blocking access to the user account further comprises removing the user from the project.

9. The method of claim 1, wherein the meeting notice is sent by way of a calendaring program and determining that the user has failed to indicate an intention to attend the meeting comprises monitoring responses using the calendaring program, wherein the calendaring program is linked to a database storing the data.

10. The method of claim 1, further comprising providing a notification to a system administrator when the user is blocked from accessing the user account.

11. The method of claim 1, wherein responding to the meeting notice by indicating that the user will not participate in the meeting comprises one or more of declining the invitation to attend and delegating attendance to another user.

12. The method of claim 1, wherein the data is accessible to a plurality of users and the meeting notice is sent to users that have access to the data, and wherein determining an intention to attend a meeting is tracked for each user.

13. The method of claim 1, further comprising recording a failure-to-attend event in response to determining that the user failed to attend the meeting after the user accepted the meeting invitation.

14. The method of claim 1, wherein the non-attendance criteria further comprises decreasing the quantity of failure-to-attend events in response to determining that the user agreed to attend a meeting.

15. The method of claim 1, wherein the non-attendance criteria further comprises a quantity of failure-to-attend events reaching a non-attendance threshold within a window of time.

16. An apparatus comprising:
an invitation status module that determines that a user has failed to indicate an intention to attend a meeting by one of
failing to respond to a meeting notice, the meeting notice comprising an invitation sent electronically to the user to attend a meeting, the user having electronic access to data by way of permissions associated with a user account assigned to the user, the meeting being related to the data; and
responding to the meeting notice by indicating that the user will not participate in the meeting;
a non-attendance tracking module that records a failure-to-attend event in response to the invitation status module determining that the user has failed to indicate an intention to attend a meeting; and
an access removal module that blocks the user from accessing the user account in response to a quantity of failure-to-attend events reaching non-attendance criteria.

17. The apparatus of claim 16, further comprising a warning module that one or more of:
notifies the user that access to the user account has been blocked in response to blocking the user from accessing the user account; and
sends a warning message to the user that access to the user account will be blocked with further non-attendance to meetings in response to the quantity of failure-to-attend events reaching warning criteria, the warning criteria being lower than the non-attendance criteria.

18. The apparatus of claim 16, further comprising an excused absence module that prevents recording a failure-to-attend event in response to an excused absence from the meeting.

19. The apparatus of claim 16, further comprising a notification module that provides a notification to a system administrator when the user is blocked from accessing the user account.

20. A system comprising:
a computer;
a data storage device in communication with the computer, the data storage device storing data;
an access removal apparatus comprising
an invitation status module that determines that a user has failed to indicate an intention to attend a meeting by one of
failing to respond to a meeting notice, the meeting notice comprising an invitation sent electronically to the user to attend a meeting, the user having electronic access to the data by way of permissions associated with a user account assigned to the user, the meeting being related to the data; and
responding to the meeting notice by indicating that the user will not participate in the meeting;
a non-attendance tracking module that records a failure-to-attend event in response to the invitation status module determining that the user has failed to indicate an intention to attend a meeting; and
an access removal module that blocks the user from accessing the user account in response to a quantity of failure-to-attend events reaching non-attendance criteria.
